(19) United States
(12) Patent Application Publication
(10) Pub. No.: US 2018/0326735 A1
(43) Pub. Date: Nov. 15, 2018

(54) Printer Chip, Ink Cartridge and Printer Chip Storage Allocation Method

(71) Applicant: HANGZHOU CHIPJET TECHNOLOGY CO.,LTD., Zhejiang (CN)

(72) Inventors: Zhengdong ZHANG, Zhejiang (CN); Yun SUN, Zhejiang (CN); Xinping PENG, Zhejiang (CN)

(21) Appl. No.: 15/774,907

(22) PCT Filed: Aug. 24, 2016
(86) PCT No.: PCT/CN2016/096488

§ 371 Date: May 9, 2018

(30) Foreign Application Priority Data
Nov. 9, 2015 (CN) 201510754337.6

(51) Int. Cl. B41J 2/175; G06F 12/14; G06F 21/73

(52) U.S. Cl. CPC B41J 2/17546; G06F 2221/2121; G06F 21/73; G06F 12/1408

(57) ABSTRACT

The invention belongs to the field of ink-jet printing, and particularly relates to a printer chip, an ink cartridge and a printer chip memory allocation method. According to the technical scheme, the printer chip comprises a chip control circuit, a data memory unit used for storing data, and a communication unit used for communication with a printer, wherein the data memory unit and the communication unit are electrically connected with the chip control circuit, and the data memory unit comprises an authorization flat bit making the data memory unit in a non-authorized state and an authorized state respectively according to different numerical values. By additionally arranging the authorization flat bit and conducting matched authorization verification, on the basis of guaranteeing data stability and reliability, chip data can be covered and rewritten, normal use is ensured, and the service life of the printer chip is prolonged.

### FIELD OF TECHNOLOGY

The invention relates to the field of ink-jet printing, in particular to a printer chip, an ink cartridge and a printer chip storage allocation method.

### BACKGROUND ART

With the popularization of office automation, printing equipment has become indispensable equipment for office activities, common printing equipment includes laser printing equipment and ink-jet printing equipment, and during ink-jet printing, an ink-jet printer and an ink cartridge mounted in the printer are included.

In the using process of the ink-jet printer, consumables such as the ink cartridge need to be replaced periodically. The ink cartridge needs to be replaced when ink in the ink cartridge is used up, the replaceable equipment such as the ink cartridge includes printing parameters, the printing parameters are generally stored in a chip, the printer chip is mounted in the replaceable equipment such as the ink cartridge so that a printer main body can obtain the data in the first time every time the replaceable equipment is replaced, and thus a good printing effect is guaranteed.

In the prior art, for guaranteeing the stability and incorrigibility of information, the information is generally written into the printer chip once, which means that the chip can only be used once and cannot be used repeatedly, and thus the use value of the chip is decreased.

### SUMMARY OF THE INVENTION

According to the purposes of the invention, by additionally arranging an authorization flag bit and conducting authorization verification matched with the authorization flag bit, on the basis of guaranteeing the stability and reliability of data, chip data can be covered, reread and rewritten, normal use is ensured, and the service life of a printer chip is prolonged.

The above technical purposes of the invention are realized through the following technical scheme: a printer chip comprises a chip control circuit, a data storage unit used for storing data, and a communication unit used for communication with a printer, wherein the data storage unit and the communication unit are electrically connected with the chip control circuit respectively; the printer chip is characterized in that:

the data storage unit comprises an authorization flag bit which makes the data storage unit in a non-authorized state and an authorized state respectively according to different numerical values;

in the non-authorized state, the data storage unit comprises a non-protected part allowing data to be read or written therein by the control circuit, and a protected part allowing data to be read by the control circuit but not allowing data to be written therein by the control circuit, and a disposable part allowing data to be read by the control circuit and only allowing disposable data to be written therein by the control circuit;

in the authorized state, the data storage unit comprises the non-protected part;

the control circuit comprises a key unit, an operation unit and a reading and writing unit;

the operation unit is used for operating input data sent from a printer main body through key data stored in the key unit so as to obtain a first check code;

the operation unit is also used for comparing a second check code sent from the printer main body with the first check code and changing the numerical value of the authorization flag bit in the data storage unit.

The printer chip is mounted on a replaceable component, the replaceable component is not authorized specifically in an ordinary service state, namely data on the authorization flag bit make the data storage unit in the non-authorized state, the data storage unit is divided into a plurality of areas at the moment and at least comprises the non-protected part, the protected part and the disposable part, and the three parts are different on the aspect of reading and writing permissions; the non-protected part allows data to be read and written therein by printing equipment such as the printer main body and is a common data operation port, data stored in the protected part are input when used for the first time, can only be read and cannot be modified or written in, for example, when the printer chip is mounted on an ink cartridge, data stored in the protected part can be the first service date of the ink cartridge, the data can only be read and cannot be modified once being written in, and a user can speculate the effective service life of the ink cartridge according to the first service date of the ink cartridge; the disposable part allows data to be written therein, however, writing can be conducted on each data bit only once, for example, it is stipulated that the binary system is adopted for data storage of the disposable part, data can be written from 0 to 1, but once data are written as 1, the data cannot be written as 0 anymore, and thus extremely high applicability is achieved during actual application, for example, data in the disposable part include multiple bits, each bit corresponds to part ink of the ink cartridge, the data are written as 1 from 0 when the part of ink is used up, and the user can work out residual ink quantity data according to data of the part, and besides, the user can also write the ink cartridge protector series number and other information into the disposable part; the user can divide the data storage unit into N data blocks, each data block corresponds to an address, the data blocks and the addresses correspond to different permissions, and thus a corresponding table of the data blocks, the addresses and the permissions is formed; when the control circuit needs to carry out corresponding operation on the data storage unit, addressing can be carried out on the data storage unit through the set table, so that the corresponding permission and the corresponding address are found out for reading and writing operation; according to one provided embodiment, the permission 0 indicates read only and corresponds to the protected part, the permission 1 indicates that writing is available and corresponds to the non-protected part, and the permission 3 indicates that bits can only be changed from 0 to 1 and corresponds to the disposable part; in addition, the permission 2 indicates the rule that only data larger than original data can be written and can be used for recording the number of printing times in actual operation, the number of printing times is increased gradually and cannot be decreased in the using process of the printer, and the user can estimate information such as the residual ink quantity according to the recorded number of printing times; when the replaceable component needs to be replaced at the end of the life, verification for special authorization needs to be performed and comprises the specific steps that the printer main body sends an instruction, and the printer chip can feed back random data, the operation unit conducts calculation according to the instruction, the random data and the key data stored in the key unit, so that a first check code is obtained; similarly, the printer main body obtains a second check code through calculation according to the instruction and the random data, and afterwards, the second check code is sent to the printer chip; the operation unit compares the first check code with the second check code; if the first check code is different from the second check code, special authorization fails; if the first check code is the same as the second check codes, special authorization succeeds, the authorization flag bit is changed at the moment, the state of the whole data storage unit is changed accordingly, and the whole data storage unit is converted into the non-protected part, namely new data can be input to the data storage unit; in this way, the printer chip can be used repeatedly, and the service life of the printer chip is prolonged.

Preferably, when the data storage unit is in the non-authorized state, the disposable part includes the ink cartridge maximum volume data.

Preferably, when the data storage unit is in the non-authorized state, the disposable part further includes ink cartridge protector serial number data and protection start bit data.

Preferably, when the data storage unit is in the non-authorized state, the protected part includes the ink cartridge first service date.

Preferably, the operation unit carries out operation through data sent from the printer main body and the key data stored in the key unit according to the AES algorithm or the DES algorithm or the EDES algorithm or the 3DES algorithm.

It has already been proved that by adoption of the internationally-standard AES algorithm or the internationally-standard DES algorithm or the internationally-standard EDES algorithm or the internationally-standard 3DES algorithm, copying and imitation are unavailable under the safe key condition, and safety of the calculation and authentication processes for special authorization is guaranteed.

An ink cartridge is provided with the printer chip described above.

A printing head is provided with the printer chip.

A printer comprises the printing head and the ink cartridge, wherein the printing head is provided with the printer chip, and the ink cartridge is provided with the printer chip.

A printer chip storage allocation method is performed through a printer main body comprising a main body operation unit and replaceable equipment provided with the printer chip and comprises the following steps of:

firstly, sending an authorization request:

specifically, the printer main body sends out an authorization request command to the printer chip;

secondly, returning random data:

specifically, random data are generated by the printer chip and sent to the printer main body through the communication unit;

thirdly, generating check codes:

specifically, the printer chip carries out encryption operation through key data stored in the key unit by using the random data as input, so that a first check code is obtained, and the main body operation unit in the printer main body obtains a second check code through the same operation method;

fourthly, comparing the check codes:

specifically, the printer main body sends the second check code to the printer chip, and the printer chip compares the first check code with the second check code;

fifthly, marking an authorization sign:

specifically, when the first check code is consistent with the second check code in the fourth step, the authorization sign is marked to be valid, and the data storage unit is switched into the authorized state, and if the first check code is inconsistent with the second check code, the data storage unit is still in the non-authorized state.

In the first step, the printer main body sends out the authorization request command to the printer chip, for example, 0x60 0x00 0x98 is sent, wherein 0x60 represents the chip address of the printer chip, and 0x00 0x98 represents the authorization request command; after the printer chip receives the authorization request command, the second step is executed, specifically, and an authorization random number is returned, for example, 0x00 0x08 0x65 0x97 0x35 0x63 0x34 0x23 0x56 0x39 is returned, wherein 0x00 0x08 indicates the data length, and 0x65 0x97 0x35 0x63 0x34 0x23 0x56 0x39 represents the 8-bit random data; the third step is executed at the moment, specifically, the printer chip carries out encryption operation through the key data stored in the key unit by using the random data as input, so that the first check code is obtained, and the main body operation unit in the printer main body obtains the second check code through the same operation method; the fourth steps is executed, specifically, the printer main body sends the second check code to the printer chip, for example, the data 0x60 0x00 0x78 0x24 0x35 0x69 0x23 0x74 0x13 0x86 0x89 0x24 0x35 0x69 0x23 0x74 0x13 0x86 0x89 are sent, wherein 0x60 still represents the data address, 0x00 0x78 represents an authorization matching command, the subsequent 0x24 0x35 0x69 0x23 0x74 0x13 0x86 0x89 0x24 0x35 0x69 0x23 0x74 0x13 0x86 0x89 represents the second check code, and the printer chip compares the second check code with the first check code worked out by the printer chip; the fifth step is executed after matching comparison, if the data are inconsistent, the authorization flag bit is not changed, namely special authorization fails; if the data are consistent, the authorization flag bit is changed, special authorization succeeds, and the non-protected part, the protected part and the disposable part originally in the data storage unit are all converted into non-protected parts.

Preferably, in the third step, the encryption operation method adopted by the printer main body and the printer chip is the AES algorithm or the DES algorithm or the EDES algorithm or the 3DES algorithm

Preferably, in the first step, the authorization request command sent by the printer main body further includes chip address data of the printer chip.

Preferably, in the third step, the input data for the encryption operation method further include fixed data fixed as 00 besides the random data.

Preferably, the replaceable equipment is an ink cartridge.

In conclusion, the invention has the following beneficial effects that:

the permission of the data storage unit can be rewritten and converted into a non-protected part, comprehensive re-inputting of data is achieved, and the service life of the printer chip is prolonged;

the AES or the DES algorithm or the EDES algorithm or the 3DES algorithm is adopted for specific authorization and authentication, and thus the safety is high;

input information for specific authorization and authentication uses the command sent from the printer main body and the random data generated by the printer chip as input, the original stored key data are used, so that the authentication calculating process is rigorous, and data safety is highly maintained.

### BRIEF DESCRIPTION OF DRAWINGS

FIG. 1 is a schematic diagram of a first embodiment;

FIG. 2 is a schematic diagram of a data storage unit in a non-authorized state in the first embodiment;

FIG. 3 is a data block diagram of the steps from the first step to the fifth step in the first embodiment;

### DETAILED DESCRIPTION OF THE INVENTION

A further detailed description of the invention is given as follows with accompanying drawings.

The specific embodiment is only used for explaining the invention, but not used for limiting the invention, those skilled in the field can obtain non-creative modifications of the embodiment of the invention according to requirements after reading the description, and all the modifications in the scope of the claims of the invention are protected by the patent law.

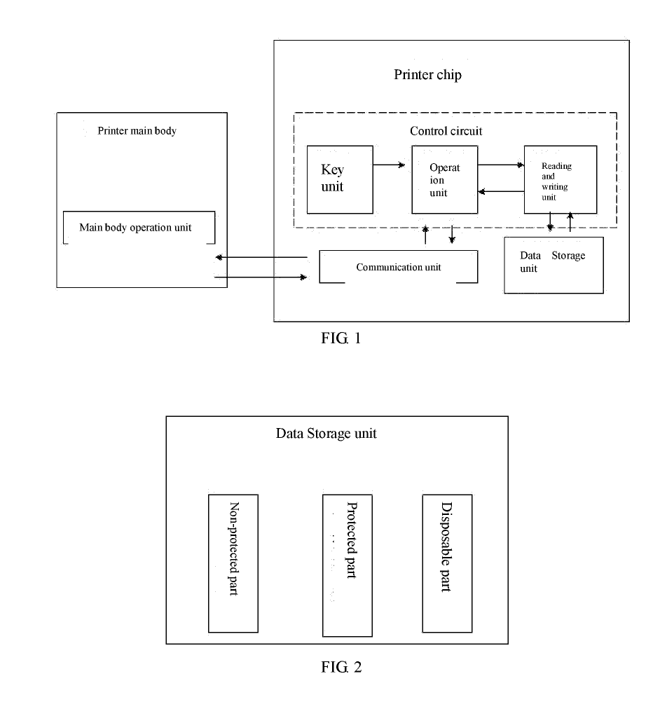

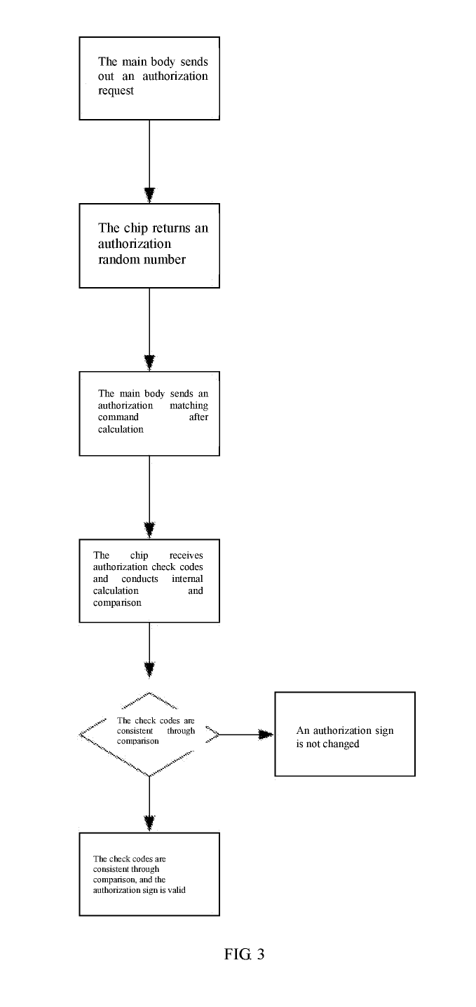

First embodiment, as is shown in FIGS. 1-2, a printer chip comprises a chip control circuit, a data storage unit used for storing data, and a communication unit used for communication with a printer, wherein the data storage unit and the communication unit are electrically connected with the chip control circuit respectively; the printer chip is characterized in that:

the data storage unit comprises an authorization flag bit which makes the data storage unit in a non-authorized state and an authorized state respectively according to different numerical values;

in the non-authorized state, the data storage unit comprises a non-protected part allowing data to be read or written therein by the control circuit, and a protected part allowing data to be read by the control circuit but not allowing data to be written therein by the control circuit, and a disposable part allowing data to be read by the control circuit and only allowing disposable data to be written therein by the control circuit;

in the authorized state, the data storage unit comprises the non-protected part;

the control circuit comprises a key unit, an operation unit and a reading and writing unit;

the operation unit is used for operating input data sent from a printer main body through key data stored in the key unit so as to obtain a first check code;

the operation unit is also used for comparing a second check code sent from the printer main body with the first check code and changing the numerical value of the authorization flag bit in the data storage unit.

The printer chip is mounted on a replaceable component, the replaceable component is not authorized specifically in an ordinary service state, namely data on the authorization flag bit make the data storage unit in the non-authorized state, the data storage unit is divided into a plurality of areas at the moment and at least comprises the non-protected part, the protected part and the disposable part, and the three parts are different on the aspect of reading and writing permissions; the non-protected part allows data to be read and written therein by printing equipment such as the printer main body and is a common data operation port, data stored in the protected part are input when used for the first time, can only be read and cannot be modified or written in, for example, when the printer chip is mounted on an ink cartridge, data stored in the protected part can be the first service date of the ink cartridge, the data can only be read and cannot be modified once being written in, and a user can speculate the effective service life of the ink cartridge according to the first service date of the ink cartridge; the disposable part allows data to be written therein, however, writing can be conducted on each data bit only once, for example, it is stipulated that the binary system is adopted for data storage of the disposable part, data can be written from 0 to 1, but once data are written as 1, the data cannot be written as 0 anymore, and thus extremely high applicability is achieved during actual application, for example, data in the disposable part include multiple bits, each bit corresponds to part ink of the ink cartridge, the data are written as 1 from 0 when the part of ink is used up, and the user can work out residual ink quantity data according to data of the part, and besides, the user can also write the ink cartridge protector series number and other information into the disposable part; the user can divide the data storage unit into N data blocks, each data block corresponds to an address, the data blocks and the addresses correspond to different permissions, and thus a corresponding table of the data blocks, the addresses and the permissions is formed; when the control circuit needs to carry out corresponding operation on the data storage unit, addressing can be carried out on the data storage unit through the set table, so that the corresponding permission and the corresponding address are found out for reading and writing operation; according to one provided embodiment, the permission 0 indicates read only and corresponds to the protected part, the permission 1 indicates that writing is available and corresponds to the non-protected part, and the permission 3 indicates that bits can only be changed from 0 to 1 and corresponds to the disposable part; in addition, the permission 2 indicates the rule that only data larger than original data can be written and can be used for recording the number of printing times in actual operation, the number of printing times is increased gradually and cannot be decreased in the using process of the printer, and the user can estimate information such as the residual ink quantity according to the recorded number of printing times; when the replaceable component needs to be replaced at the end of the life, verification for special authorization needs to be performed and comprises the specific steps that the printer main body sends an instruction, and the printer chip can feed back random data, the operation unit conducts calculation according to the instruction, the random data and the key data stored in the key unit, so that a first check code is obtained; similarly, the printer main body obtains a second check code through calculation according to the instruction and the random data, and afterwards, the second check code is sent to the printer chip; the operation unit compares the first check code with the second check code; if the first check code is different from the second check code, special authorization fails; if the first check code is the same as the second check codes, special authorization succeeds, the authorization flag bit is changed at the moment, the state of the whole data storage unit is changed accordingly, and the whole data storage unit is converted into the non-protected part, namely new data can be input to the data storage unit; in this way, the printer chip can be used repeatedly, and the service life of the printer chip is prolonged.

When the data storage unit is in the non-authorized state, the disposable part includes the ink cartridge maximum volume data, ink cartridge protector serial number data and protection start bit data.

When the data storage unit is in the non-authorized state, the protected part includes the ink cartridge first service date.

The operation unit carries out operation through data sent from the printer main body and the key data stored in the key unit according to the AES algorithm or the DES algorithm or the EDES algorithm or the 3DES algorithm. It has already been proved that by adoption of the AES algorithm or the DES algorithm or the EDES algorithm or the 3DES algorithm, copying and imitation are unavailable under the safe key condition, and safety of the calculation and authentication process for specific authorization is guaranteed.

A printer chip storage allocation method is performed through a printer main body comprising a main body operation unit and replaceable equipment provided with the printer chip and comprises the following steps of:

firstly, sending an authorization request:

specifically, the printer main body sends out an authorization request command to the printer chip;

secondly, returning random data:

specifically, random data are generated by the printer chip and sent to the printer main body through the communication unit;

thirdly, generating check codes:

specifically, the printer chip carries out encryption operation through key data stored in the key unit by using the random data as input, so that a first check code is obtained, and the main body operation unit in the printer main body obtains a second check code through the same operation method;

fourthly, comparing the check codes:

specifically, the printer main body sends the second check code to the printer chip, and the printer chip compares the first check code with the second check code;

fifthly, marking an authorization sign:

specifically, when the first check code is consistent with the second check code in the fourth step, the authorization sign is marked to be valid, and the data storage unit is switched into the authorized state, and if the first check code is inconsistent with the second check code, the data storage unit is still in the non-authorized state.

In the first step, the printer main body sends out the authorization request command to the printer chip, for example, 0x60 0x00 0x98 is sent, wherein 0x60 represents the chip address of the printer chip, and 0x00 0x98 represents the authorization request command; after the printer chip receives the authorization request command, the second step is executed, specifically, and an authorization random number is returned, for example, 0x00 0x08 0x65 0x97 0x35 0x63 0x34 0x23 0x56 0x39 is returned, wherein 0x00 0x08 indicates the data length, and 0x65 0x97 0x35 0x63 0x34 0x23 0x56 0x39 represents the 8-bit random data; the third step is executed at the moment, specifically, the printer chip carries out encryption operation through the key data stored in the key unit by using the random data as input, so that the first check code is obtained, and the main body operation unit in the printer main body obtains the second check code through the same operation method; the fourth steps is executed, specifically, the printer main body sends the second check code to the printer chip, for example, the data 0x60 0x00 0x78 0x24 0x35 0x69 0x23 0x74 0x13 0x86 0x89 0x24 0x35 0x69 0x23 0x74 0x13 0x86 0x89 are sent, wherein 0x60 still represents the data address, 0x00 0x78 represents an authorization matching command, the subsequent 0x24 0x35 0x69 0x23 0x74 0x13 0x86 0x89 0x24 0x35 0x69 0x23 0x74 0x13 0x86 0x89 represents the second check code, and the printer chip compares the second check code with the first check code worked out by the printer chip; the fifth step is executed after matching comparison, if the data are inconsistent, the authorization flag bit is not changed, namely special authorization fails; if the data are consistent, the authorization flag bit is changed, special authorization succeeds, and the non-protected part, the protected part and the disposable part originally in the data storage unit are all converted into non-protected parts.

1. A printer chip, comprising a chip control circuit, a data storage unit used for storing data, and a communication unit used for communication with a printer, wherein the data storage unit and the communication unit are electrically connected with the chip control circuit; wherein:
the data storage unit comprises an authorization flat bit which makes the data storage unit in a non-authorized state and an authorized state according to different numerical values;
in the non-authorized state, the data storage unit comprises a non-protected part allowing data to be read or written therein by the chip control circuit, and a protected part allowing data to be read by the chip control circuit but not allowing data to be written therein by the chip control circuit, and a disposable part allowing data to be read by the chip control circuit and only allowing disposable data to be written therein by the chip control circuit;
in the authorized state, the data storage unit comprises the non-protected part;
the chip control circuit comprises a key unit, an operation unit and a reading and writing unit;
the operation unit is used for operating input data sent from a printer main body through key data stored in the key unit so as to obtain a first check code;
the operation unit is also used for comparing a second check code sent from the printer main body with the first check code and changing the numerical value of the authorization flat bit in the data storage unit.

2. The printer chip according to claim 1, wherein when the data storage unit is in the non-authorized state, the disposable part includes the ink cartridge maximum volume data.

3. The printer chip according to claim 2, wherein when the data storage unit is in the non-authorized state, the disposable part further includes ink cartridge protector serial number data and protection start bit data.

4. The printer chip according to claim 1, wherein when the data storage unit is in the non-authorized state, the protected part includes the ink cartridge first service date.

5. The printer chip according to claim 1, wherein the operation unit carries out operation through data sent from the printer main body and the key data stored in the key unit according to the AES algorithm or the DES algorithm or the EDES algorithm or the 3DES algorithm.

6. An ink cartridge, wherein the ink cartridge is provided with the printer chip according to claim 1.

7. A printer, comprising a printing head and an ink cartridge, wherein the ink cartridge is provided with the printer chip according to claim 1.

8. A printer chip storage allocation method, performed through a printer main body comprising a main body operation unit and replaceable equipment provided with the printer chip according to claim 1; comprising the following steps of:
firstly, sending an authorization request, wherein the sending including the printer main body sends out an authorization request command to the printer chip;
secondly, returning random data, wherein the returning includes random data are generated by the printer chip and sent to the printer main body through the communication unit;
thirdly, generating check codes, wherein the generating includes the printer chip carries out an encryption operation through key data stored in the key unit by using the random data as input, so that a first check code is obtained, and the main body operation unit in the printer main body obtains a second check code through the same operation method;
fourthly, comparing the check codes, the comparing including the printer main body sends the second check code to the printer chip, and the printer chip compares the first check code with the second check code;
fifthly, marking an authorization sign, the marking including when the first check code is consistent with the second check code in the fourth step, the authorization sign is marked to be valid, and the data storage unit is switched into the authorized state, and if the first check code is inconsistent with the second check code, the data storage unit is still in the non-authorized state.

9. The printer chip storage allocation method according to claim 8, wherein in the third step, the encryption operation method adopted by the printer main body and the printer chip is the AES algorithm or the DES algorithm or the EDES algorithm or the 3DES algorithm.

10. The printer chip storage allocation method according to claim 8, wherein in the first step, the authorization request command sent by the printer main body further includes chip address data of the printer chip.

11. The printer chip storage allocation method according to claim 8, wherein in the third step, the input data for the encryption operation method further include fixed data fixed as 00 besides the random data.

12. The printer chip storage allocation method according to claim 8, wherein the replaceable equipment is an ink cartridge.

13. The printer chip according to claim 2, wherein that the operation unit carries out operation through data sent from the printer master device and the key data stored in the key unit according to the AES algorithm or the DES algorithm or the EDES algorithm or the 3DES algorithm.

14. The printer chip according to claim 3, wherein that the operation unit carries out operation through data sent from the printer master device and the key data stored in the key unit according to the AES algorithm or the DES algorithm or the EDES algorithm or the 3DES algorithm.

15. The printer chip according to claim 4, wherein that the operation unit carries out operation through data sent from the printer master device and the key data stored in the key unit according to the AES algorithm or the DES algorithm or the EDES algorithm or the 3DES algorithm.

16. The ink cartridge of claim 6, wherein when the data storage unit of the printer chip is in the non-authorized state, the disposable part includes the ink cartridge maximum volume data.

17. The ink cartridge of claim 16, wherein when the data storage unit of the printer chip is in the non-authorized state, the disposable part further includes ink cartridge protector serial number data and protection start bit data.

18. The ink cartridge of claim 6, wherein when the data storage unit of the printer chip is in the non-authorized state, the protected part includes the ink cartridge first service date.

19. The ink cartridge of claim 6, wherein the operation unit carries out operation through data sent from the printer main body and the key data stored in the key unit according to the AES algorithm or the DES algorithm or the EDES algorithm or the 3DES algorithm.

20. A printer chip memory allocation method, performed through a printer master device comprising a main operation unit and replaceable equipment provided with the printer chip according to claim 2; comprising the following steps of:
firstly, sending an authorization request, wherein the sending includes the printer master device sends out an authorization request command to the printer chip;
secondly, returning random data, wherein the returning includes random data generated by the printer chip and sent to the printer master device through the communication unit;
thirdly, generating check codes, wherein the generating includes the printer chip carries out an encryption operation through key data stored in the key unit by using the random data as input, so that a first check code is obtained, and the main operation unit in the printer master device obtains a second check code through the same operation method;
fourthly, comparing the check codes, wherein the comparing includes the printer master device sends the second check code to the printer chip, and the printer chip compares the first check code with the second check code;
fifthly, marking an authorization sign, wherein the marking includes when the first check code is consistent with the second check code in the fourth step, the authorization sign is marked to be valid, and the data memory unit is switched into the authorized state, and if the first check code is inconsistent with the second check code, the data memory unit is still in the non-authorized state.

21. The printer chip memory allocation method of claim 20, wherein when the data storage unit is in the non-authorized state, the disposable part further includes ink cartridge protector serial number data and protection start bit data.
